(19) United States
(12) Patent Application Publication
(10) Pub. No.: US 2013/0335224 A1
(43) Pub. Date: Dec. 19, 2013

(54) CHARGING DEVICE WITH ANTI-THEFT FUNCTION

(71) Applicant: MIN GOOD Electric Enterprise Co., Ltd., Pingtung (TW)

(72) Inventor: Ming-Chih Tang, Pingtung (TW)

(21) Appl. No.: 13/905,978

(22) Filed: May 30, 2013

(30) Foreign Application Priority Data
Jun. 18, 2012 (TW) 101211665

(51) Int. Cl. G08B 13/14

(52) U.S. Cl. CPC G08B 13/1445
USPC 340/568.3

(57) ABSTRACT

A charging device with anti-theft function includes a power-supplying unit, a load-connecting unit and an anti-theft unit. The anti-theft unit includes a detector component connected electrically to the load-connecting unit, a control module connected electrically to the detector component, and an alarm module connected electrically to the control module. The detector component is configured to generate a charge detect signal when electricity from the power-supplying unit is transferred to a load through the load-connecting unit. The control module is configured to deactivate the alarm module in response to receipt of the charge detect signal from the detector component.

### CROSS-REFERENCE TO RELATED APPLICATION

This application claims priority of Taiwanese Application No. 101211665, filed on Jun. 18, 2012.

### BACKGROUND OF THE INVENTION

1. Field of the Invention

The present invention relates to a charging device, more particularly to a charging device with an anti-theft function.

2. Description of the Related Art

Generally speaking, computers, communication devices and consumer electronics (3C) products are charged via a plug or a universal serial bus (USB). With the development of manufacturing technology, 3C products are becoming even lighter and smaller. As a result, the 3C products are vulnerable to being stolen by others when disposed on a table while being charged.

Consequently, a conventional anti-theft charging device has been proposed to alleviate the above-mentioned vulnerability. As shown in FIG. 1, the conventional anti-theft charging device 1 includes a base 11, a frame 12 pivoted to the base 11, a connecting rope 13 connected between the base 11 and the frame 12, a locking component 14 for locking the connecting rope 13, and a charger 101 that is mounted to the base 11 and that is for charging a 3C product disposed on the base 11. The charger 101 cooperates with the locking component 14, the connecting rope 13, the frame 12 and the base 11 to place the 3C product in a particular position and to prevent theft of the 3C product from the anti-theft charging device 1.

However, the conventional anti-theft charging device 1 is bulky, making it inconvenient for users to store and carry. Moreover, the conventional anti-theft charging device 1 should be adjusted correspondingly for different shapes and sizes of the chargers 101 and the 3C products. Furthermore, the locking component 14 merely provides a passive anti-theft function.

### SUMMARY OF THE INVENTION

Therefore, an object of the present invention is to provide a charging device with an anti-theft function that may alleviate the above drawbacks of the prior art.

Accordingly, a charging device with anti-theft function of the present invention is for charging a load, and includes a power-supplying unit, a load-connecting unit and an anti-theft unit.

The power-supplying unit is for providing electricity. The load-connecting unit includes an output component connected electrically to the power-supplying unit and to be connected electrically to the load for transferring the electricity from the power-supplying unit to the load. The anti-theft unit includes a detector component connected electrically to the output component, a control module connected electrically to the detector component, and an alarm module connected electrically to the control module.

The detector component is configured to generate a charge detect signal when the electricity from the power-supplying unit is being transferred to the load through the output component. The control module is configured to deactivate the alarm module in response to receipt of the charge detect signal from the detector component.

### BRIEF DESCRIPTION OF THE DRAWINGS

Other features and advantages of the present invention will become apparent in the following detailed description of the preferred embodiment with reference to the accompanying drawings, of which:

FIG. 1 is a side view of a conventional anti-theft charging device;

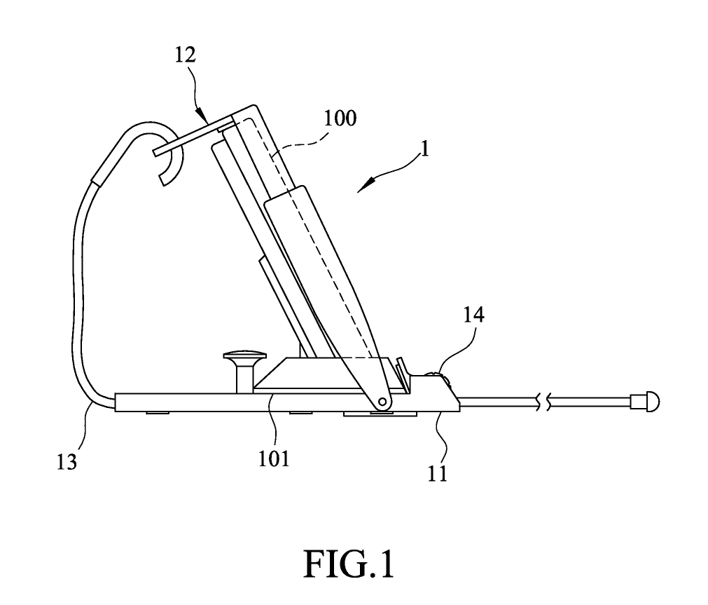

FIG. 2 is a perspective view of a first preferred embodiment of a charging device with anti-theft function according to the present invention;

FIG. 3 is a block diagram of the first preferred embodiment of the charging device with anti-theft function according to the present invention;

FIG. 4 is a circuit diagram of a power-supplying unit, a load-connecting unit and an anti-theft unit of the first preferred embodiment;

FIG. 5 is a circuit diagram of a first alarm module and a second alarm module of the anti-theft unit of the first preferred embodiment;

FIG. 6 is a circuit diagram of a remote controller and a control circuit of the anti-theft unit of the first preferred embodiment;

FIG. 7 is a block diagram of an anti-theft unit of the second preferred embodiment of the charging device with anti-theft function according to the present invention;

FIG. 8 is a circuit diagram of a power-supplying unit and a load-connecting unit of the second preferred embodiment;

FIG. 9 is a circuit diagram of an anti-theft unit of the second preferred embodiment;

FIG. 10 is a block diagram of the third preferred embodiment of the charging device with anti-theft function according to the present invention;

FIG. 11 is a circuit diagram of a power-supplying unit and a load-connecting unit of the third preferred embodiment; and

FIG. 12 is a circuit diagram of an anti-theft unit of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

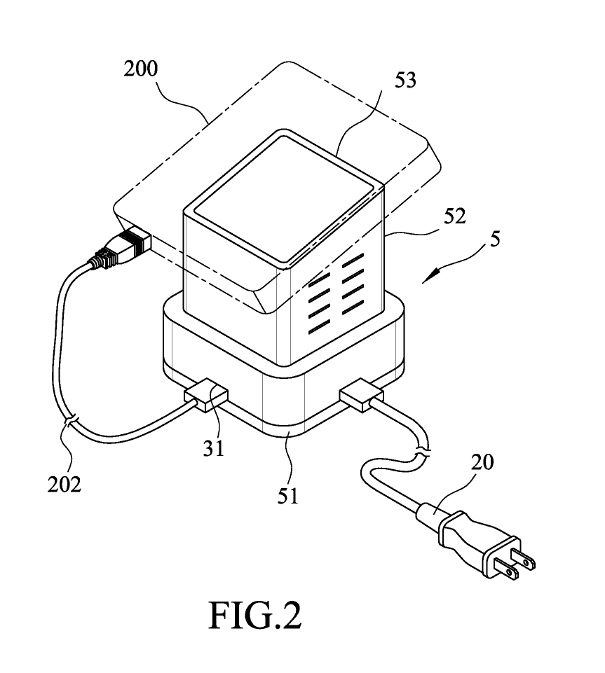

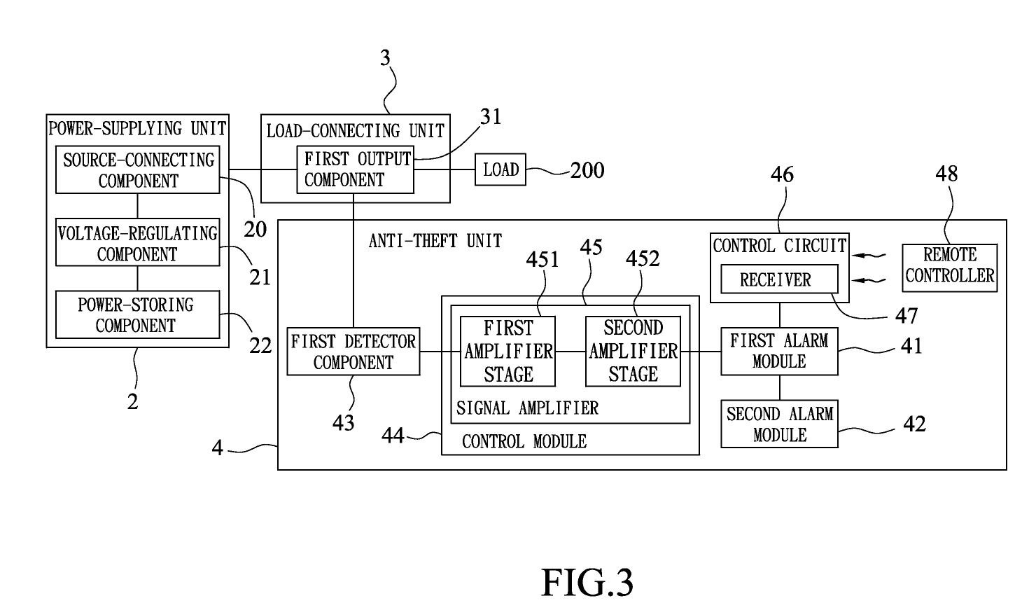

Referring to FIGS. 2 and 3, a first preferred embodiment of a charging device with anti-theft function according to the present invention is for charging a first load 200. The charging device includes a power-supplying unit 2 for providing electricity, a load-connecting unit 3 connected electrically to the power-supplying unit 2, an anti-theft unit 4 connected electrically to the load-connecting unit 3, and a casing unit 5. The casing unit 5 has the power-supplying unit 2, the load-connecting unit 3 and the anti-theft unit 4 disposed therein. In this preferred embodiment, the first load 200 is a media player, but may be other electronic devices such as a mobile phone, a tablet computer, etc.

The casing unit 5 includes a base 51, a support 52 connected to the base 51, and a top plate 53 that is connected to the support 52 and that is configured for placement of the load 200 thereon.

Referring to FIGS. 2 to 4, the power-supplying unit includes a source-connecting component 20, a voltage-regulating component 21 and a power-storing component 22. The source-connecting component 20 is adapted to be connected electrically to a power source for receiving electric power therefrom. The voltage-regulating component 21 is disposed in the base 51 of the casing unit 5, is connected electrically to source-connecting component 20, and is operable to regulate the electric power received therefrom.

The power-storing component 22 is connected electrically to the voltage-regulating component 21 for storing electricity received therefrom. In this preferred embodiment, the source-connecting component 20 is a plug configured for electrical connection to a commercial AC power source. However, the source-connecting component 20 in other preferred embodiments may serve as a plug of a charger, and the power-storing component 22 serves as a battery of the charger.

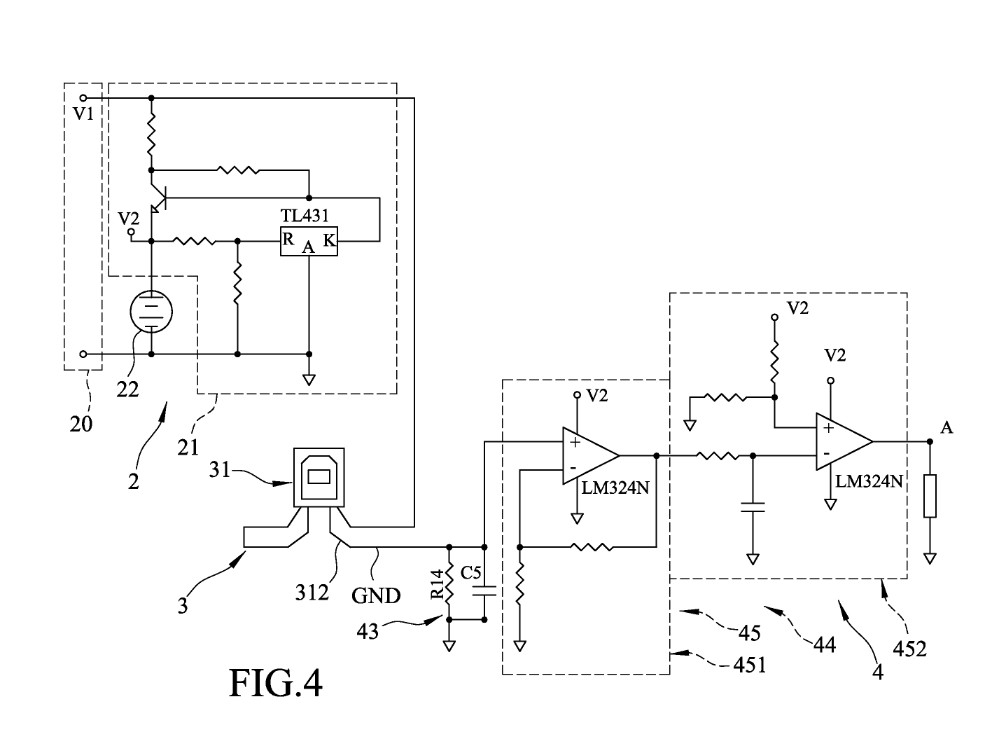

The load-connecting unit 3 includes a first output component 31 that is connected electrically to the voltage-regulating component 21 of the power-supplying unit 2 and that is connected electrically to the first load 200 for transferring the electricity from the power-supplying unit 2 to the first load 200. In this preferred embodiment, the first output component 31 is a universal serial bus (USB) connector having a Ground pin 312 (i.e., GND in FIG. 4).

Referring to FIGS. 3 to 5, the anti-theft unit 4 includes a first alarm module 41, a second alarm module 42, a first detector component 43 and a control module 44. The first detector component 43 is connected electrically to the Ground pin 312 of the first output component 31, and is configured to generate a charge detect signal when the electricity from the power-supplying unit 2 is being transferred to the first load 200 through the first output component 31. The control module 44 is connected electrically between the first detector component 43 and the first alarm module 41, and is configured to deactivate the first alarm module 41 in response to receipt of the charge detect signal from the first detector component 43.

In this preferred embodiment, the first detector component 43 is a RC circuit including a resistor (R14) and a capacitor (C5) connected in parallel to the resistor (R14). The first detector component 43 has two ends, one of which is connected electrically to the Ground pin 312 of the first output component 31, and the other one of which is grounded. The charge detect signal generated by the first detector component 43 is a voltage across the RC circuit.

Referring to FIGS. 3 to 6, the control module 44 includes a signal amplifier 45 that is connected electrically to the first detector component 43 and that is operable to amplify and invert the charge detect signal so as to generate a control signal. The first and second alarm modules 41, 42 are deactivated upon receipt of the control signal from the signal amplifier 45.

In this preferred embodiment, the signal amplifier 45 includes a first amplifier stage 451 connected electrically to the first detector component 43 and a second amplifier stage 452 connected electrically to the first amplifier stage 451. The first and second amplifier stages 451, 452 are operable to amplify and invert the charge detect signal generated by the first detector component 43 so as to generate the control signal.

The first alarm module 41 is deactivated when the control module 44 receives the charge detect signal from the first detector component 43, and is activated to generate a first alarm output when the control module 44 does not receive the charge detect signal from the first detector component 43. The second alarm module 42 is connected electrically to the first alarm module 41, and is activated to generate a second alarm output when the first alarm module 41 generates the first alarm output. In this preferred embodiment, the first alarm output is an audible alarm output, and the second alarm output is a visible alarm output.

The power-storing component 22 is connected electrically to the control module 44 and the first and second alarm modules 41, 42, and electricity stored in the power-storing component 22 is provided to the control module 44 and the first and second alarm modules 41, 42. The first and second alarm modules 41, 42 are disposed in the support 52 of the casing unit 5 (as best shown in FIG. 2). In this preferred embodiment, the support 52 is light-transmissive.

The anti-theft unit 4 further includes a control circuit 46 and a remote controller 48. The control circuit 46 includes a receiver 47, and is connected electrically to the first alarm module 41.

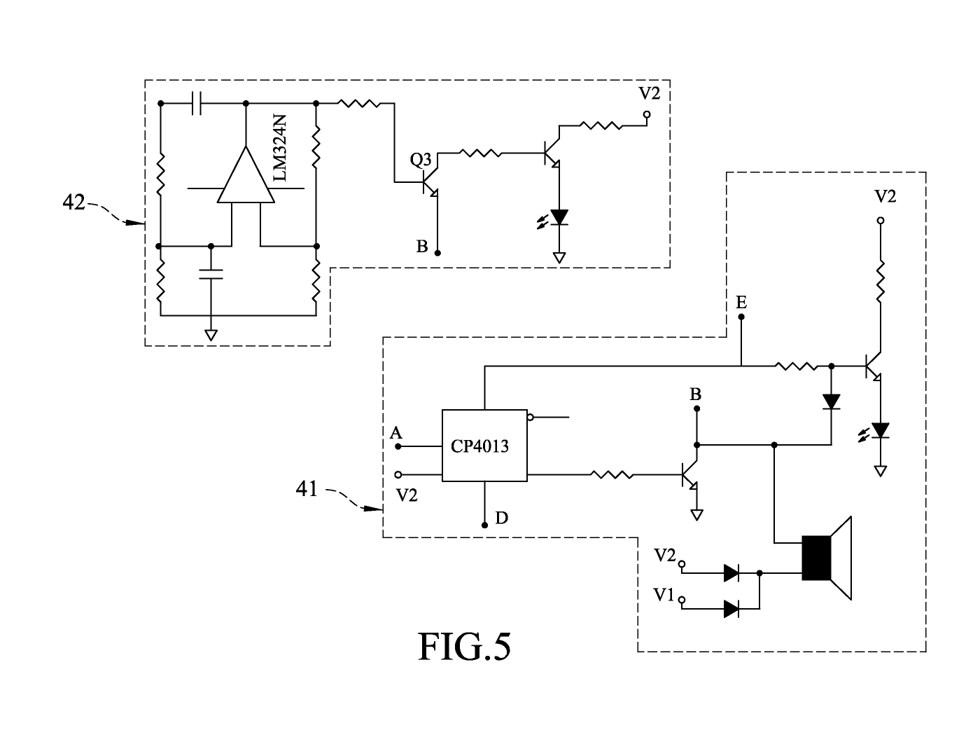

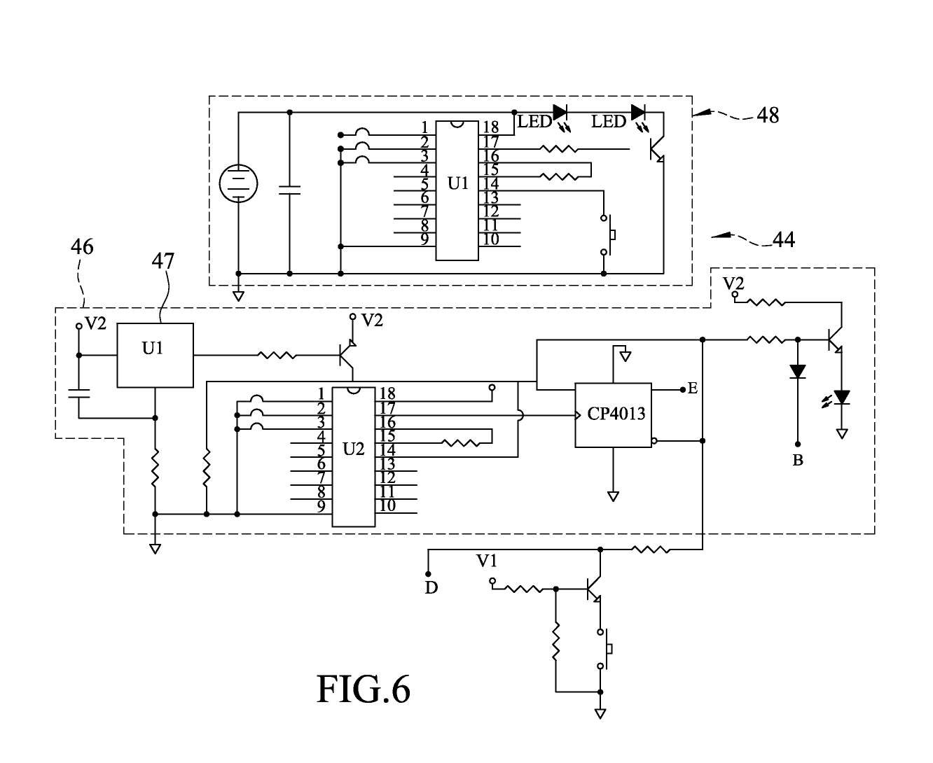

Referring to FIGS. 5 and 6, the remote controller 48 is operable to transmit a disable signal, and the receiver 47 is for receiving the disable signal. Accordingly, the control circuit 46 is configured to disable generation of the first alarm output by the first alarm module 41 in response to receipt of the disable signal from the remote controller 48, thereby deactivating the second alarm module 42 to step generation of the second alarm output.

Referring back to FIGS. 2 to 4, electricity received from the voltage-regulating component 21 is provided to the power-storing component 22 and the load-connecting unit 3, and eventually, to the load 200 via a cable 202 connected electrically between the load 200 and the first output component 31 of the load-connecting unit 3.

Referring to FIGS. 2 to 5, when the load 200 is being charged, a charge detect signal (i.e., 1), is generated across the first detector component 43 as a result of flow of electrical current therethrough. The charge detect signal from the first detector component 43 is amplified by the first amplifier stage 451, and is further amplified as well as inverted by the second amplifier stage 452. Accordingly, the control module 44 deactivates the first and second alarm modules 41, 42, and the first and the second alarm outputs (i.e., the audible alarm output and the visible alarm output) are not generated at this time.

When the cable 202 is removed to disconnect from one of the load 200 and the first output component 31 of the load-connecting unit 3, no voltage is present across the first detector component 43. At this time, the control module 44 activates the first and second alarm modules 41, 42 to generate the audible alarm output and the visible alarm output, respectively. Specifically, the visible alarm output is transmitted outwardly from the second alarm module 42 through the support 52 of the casing unit 5.

Referring to FIGS. 5 and 6, the remote controller 48 is operable by a user to transmit the disable signal for reception by the receiver 47 of the control circuit 46. In response to receipt of the disable signal from the remote controller 48, the control circuit 46 disables generation of the audible alarm output, as well as the visible alarm output, by the first and second alarm modules 41, 42.

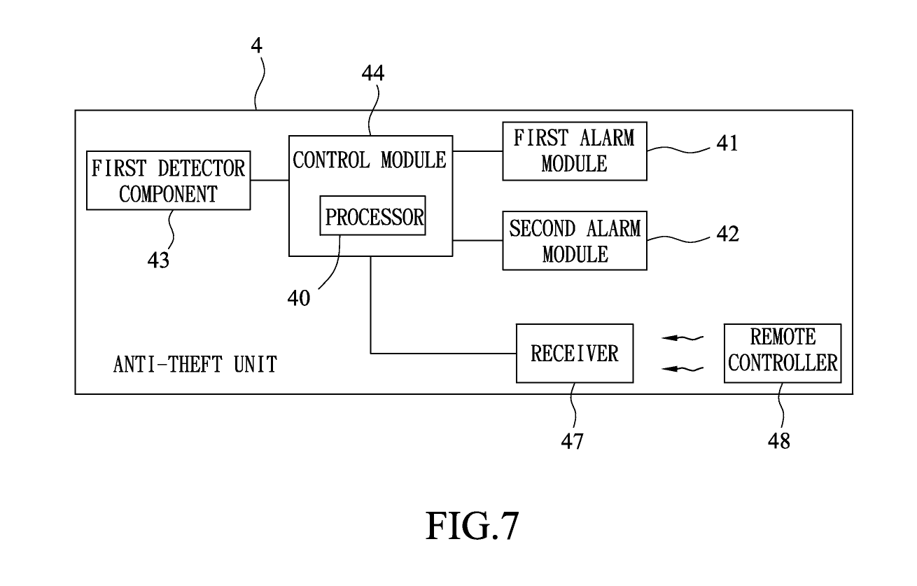

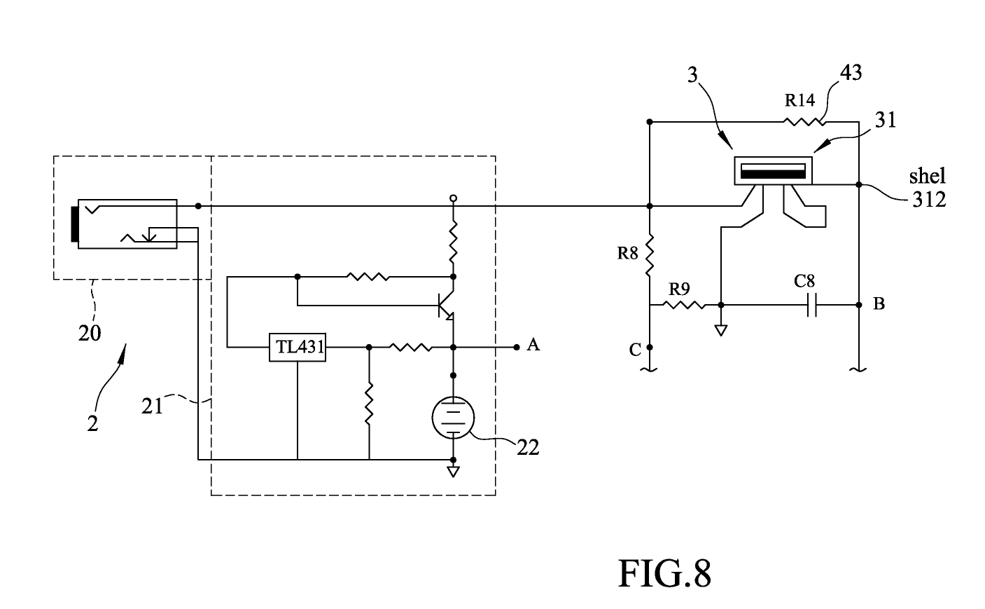

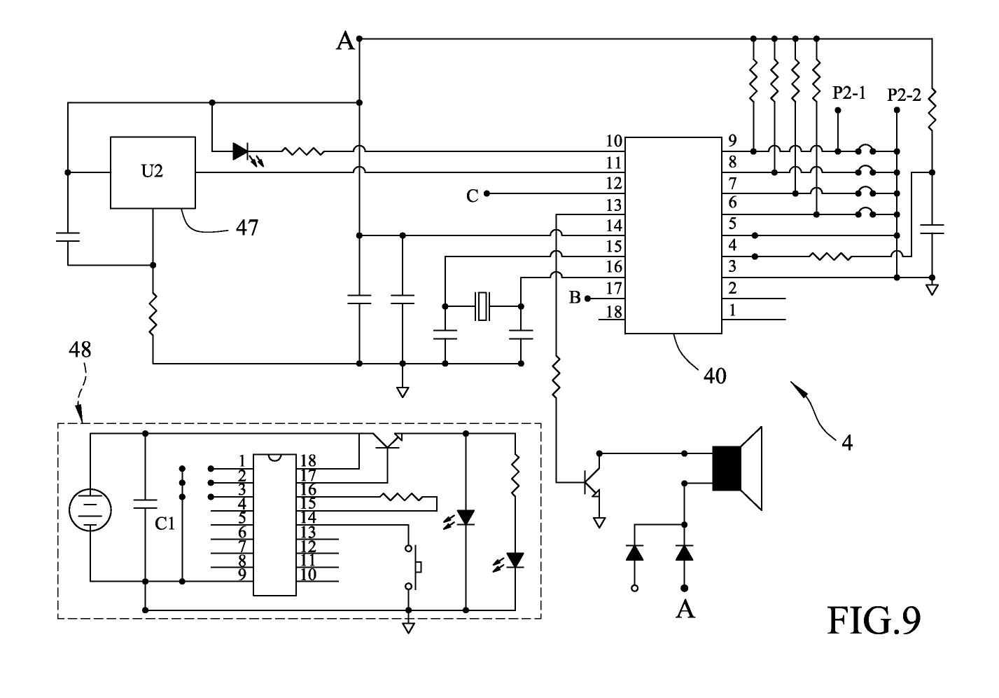

Referring to FIGS. 7 to 9, a second preferred embodiment of the present invention is shown to be similar to the first preferred embodiment. The only difference resides in that the control module 44 includes a processor 40 connected electrically to the first detector component 43, the first alarm module 41 and the second alarm module 42. In this preferred embodiment, the first output component 31 has a conductive shell 312 (i.e., shel in FIG. 8). The first detector component 43 includes the first resistor (R14) connected at one end to the conductive shell 312, and a series connection of a capacitor (C8), a second resistor (R8) and a third resistor (R9), the series connection being connected in parallel to the first resistor (R14). The charge detect signal is generated across the first resistor (R14).

Referring to FIGS. 2 and 7 to 9, when the cable 202 is connected electrically between the load 200 and the first output component 31 of the load-connecting unit 3, the conductive shell 312 is grounded and the charge detect signal is generated. When the charge detect signal is received from the first detector component 43, the processor 40 deactivates the first and second alarm modules 41, 42 to generate the audible alarm output and the visible alarm output.

On the other hand, when the cable 202 is removed to disconnect from one of the load 200 and the first output component 31 of the load-connecting unit 3, the conductive shell 312 is floating. When the charge detect signal is not received from the first detector component 43, the processor 40 activates the first and second alarm modules 41, 42 to generate the audible alarm output and the visible alarm output. The remote controller 48 is operable by the user to transmit the disable signal for reception by the receiver 47. In response to receipt of the disable signal from the remote controller 48, the process or 40 disables generation of the audible alarm output and the visible alarm output by the first and second alarm modules 41, 42.

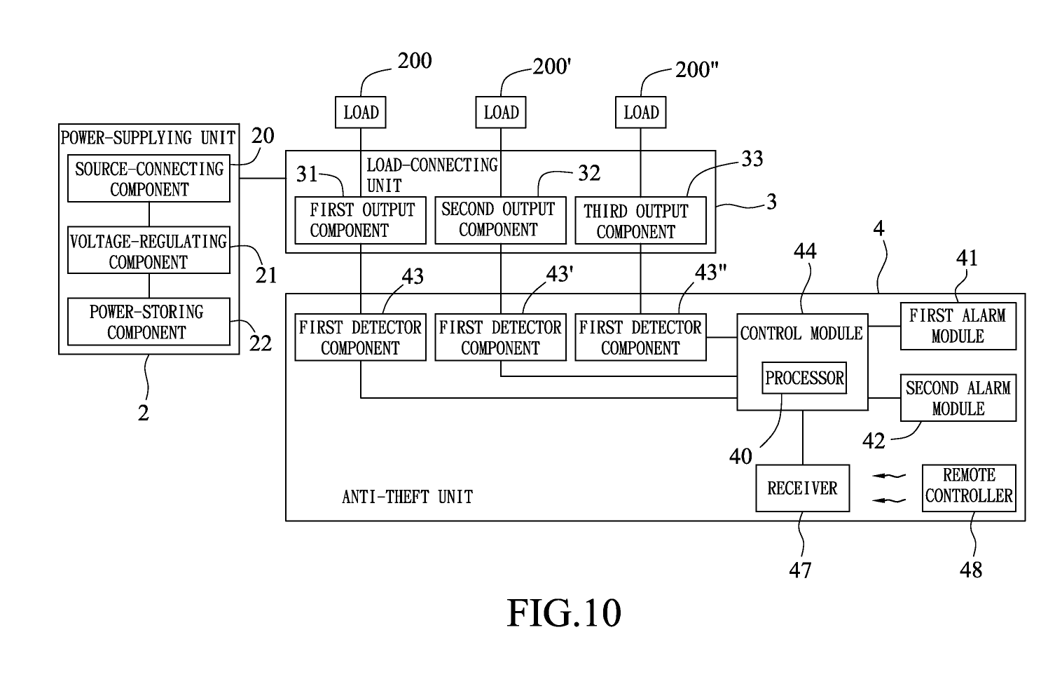

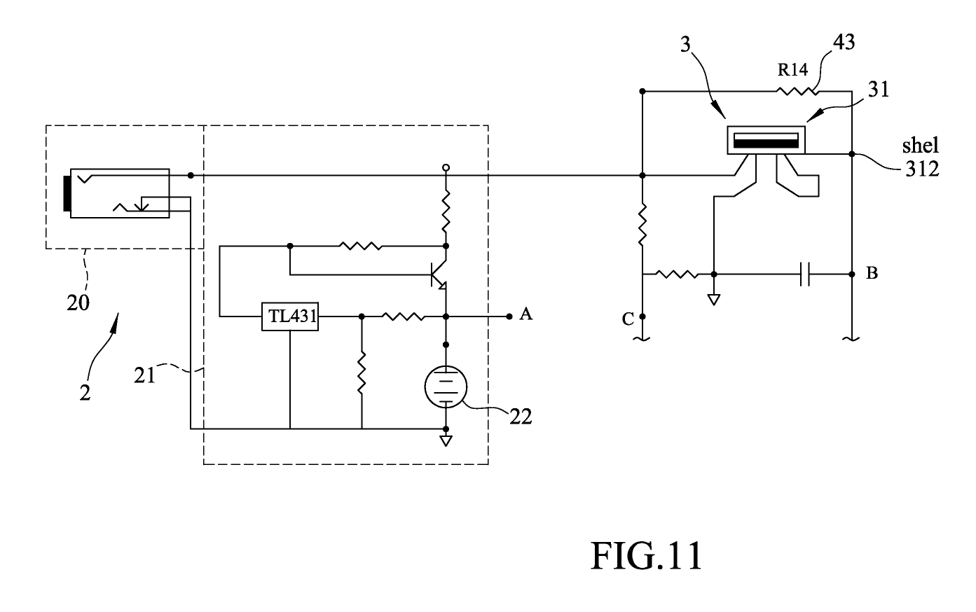

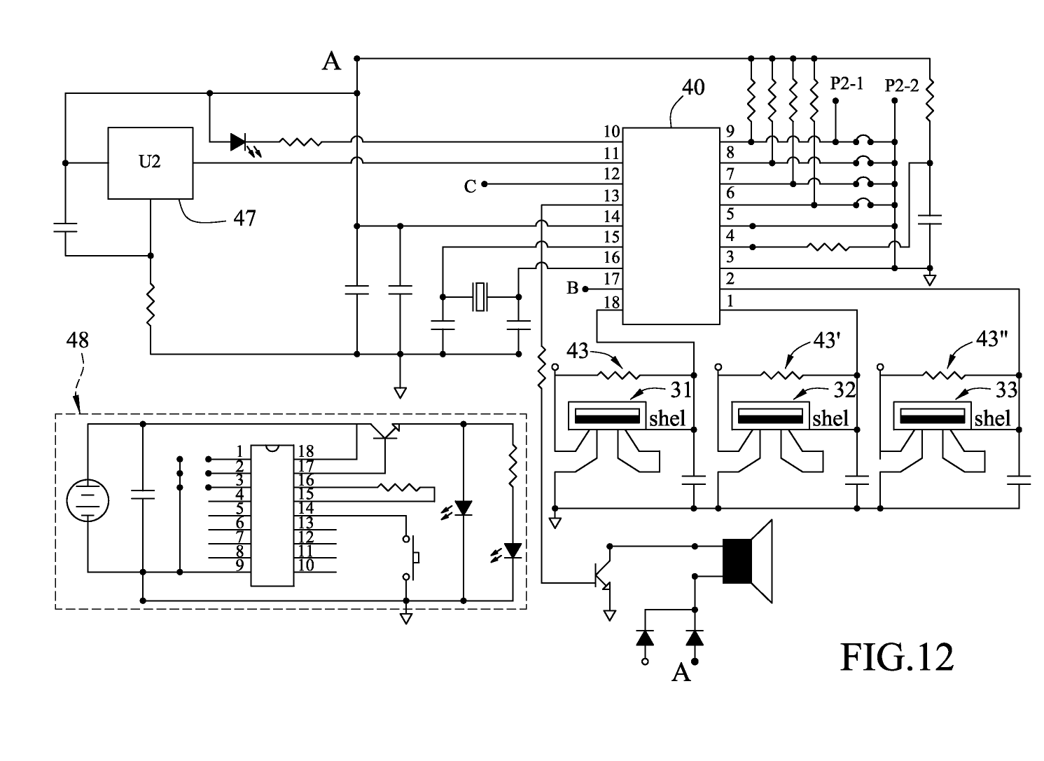

Referring to FIGS. 10 to 12, a third preferred embodiment of the present invention is shown to be similar to the second preferred embodiment. The only difference resides in that the load-connecting unit 3 of the charging device further includes a second output component 32 and a third output component 33, and correspondingly, the anti-theft unit 4 further includes a second detector component 43′ and a third detector component 43″ connected electrically to the second output component 32 and the third output component 33, respectively. The second output component 33 and the third output component 34 are connected electrically to a second load 200′ and to a third load 200″ for transferring the electricity from the power-supplying unit 2 to the second and third loads 200′, 200″, respectively.

In other words, the charging device in this preferred embodiment may charge the first, second and third loads 200, 200′, 200″ simultaneously.

To conclude, the charging device of the present invention is characterized in that the control module 44 of the anti-theft unit 4 may control operation of the first alarm module 41 according to the charge detect signal from the first detector component 43. Moreover, the charging device of the present invention does not require corresponding adjustment to fit different shapes and sizes of various types of the loads 200, 200′, 200″. Furthermore, the size of the charging device of the present invention may be small enough for the user to carry or store.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A charging device for charging a first load, said charging device comprising:
a power-supplying unit for providing electricity;
a load-connecting unit including a first output component connected electrically to said power-supplying unit and to be connected electrically to the first load for transferring the electricity from said power-supplying unit to the first load; and
an anti-theft unit including a first detector component connected electrically to said first output component, a control module connected electrically to said first detector component, and a first alarm module connected electrically to said control module;
wherein said first detector component is configured to generate a charge detect signal when the electricity from said power-supplying unit is being transferred to the first load through said first output component; and
wherein said control module is configured to deactivate said first alarm module in response to receipt of the charge detect signal from said first detector component.

2. The charging device as claimed in claim 1, wherein said power-supplying unit includes:
a source-connecting component adapted to be connected electrically to a power source for receiving electric power therefrom;
a voltage-regulating component connected electrically to said source-connecting component, operable to regulate the electric power received therefrom, and connected electrically to said first output component for providing electricity thereto; and
a power-storing component connected electrically to said voltage-regulating component for storing electricity received therefrom and connected electrically to said control module and said first alarm module for providing electricity thereto.

3. The charging device as claimed in claim 1, wherein said control module includes a signal amplifier connected electrically to said first detector component and operable to amplify and invert the charge detect signal so as to generate a control signal, and said first alarm module is deactivated upon receipt of the control signal from said signal amplifier.

4. The charging device as claimed in claim 1, wherein said first alarm module is deactivated when said control module receives the charge detect signal from said first detector component, and is activated to generate a first alarm output when said control module does not receive the charge detect signal from said first detector component.

5. The charging device as claimed in claim 4, wherein said anti-theft unit further includes a second alarm module that is connected electrically to said first alarm module, and that is activated to generate a second alarm output when said first alarm module generates the first alarm output, and
wherein one of the first and second alarm outputs is an audible alarm output and the other one of the first and second alarm outputs is a visible alarm output.

6. The charging device as claimed in claim 4, wherein said anti-theft unit further includes:
a remote controller operable to transmit a disable signal; and
a control circuit including a receiver for receiving the disable signal, said control circuit being connected electrically to said first alarm module and being configured to disable generation of the first alarm output by said first alarm module in response to receipt of the disable signal from said remote controller.

7. The charging device as claimed in claim 1, wherein said first output component is a universal serial bus connector having a Ground pin, and said first detector component includes a resistor connected at one end to said Ground pin, the charge detect signal being generated across said resistor.

8. The charging device as claimed in claim 7, wherein said first detector component further includes a capacitor connected in parallel to said resistor.

9. The charging device as claimed in claim 1, wherein said control module includes a processor connected electrically to said first detector component and said first alarm module.

10. The charging device as claimed in claim 9, wherein said processor activates said first alarm module to generate a first alarm output when the charge detect signal is not received from said first detector component.

11. The charging device as claimed in claim 10, wherein said anti-theft unit further includes a second alarm module that is connected electrically to said processor, and that is activated by said processor to generate a second alarm output when the charge detect signal is not received from said first detector component, and wherein one of the first and second alarm outputs is an audible alarm output and the other one of the first and second alarm outputs is a visible alarm output.

12. The charging device as claimed in claim 10, wherein said anti-theft unit further includes:
a remote controller operable to transmit a disable signal; and
a receiver for receiving the disable signal and connected electrically to said processor, said processor being configured to disable generation of the first alarm output by said first alarm module in response to receipt of the disable signal from said remote controller.

13. The charging device as claimed in claim 1, wherein said first output component is a universal serial bus connector having a conductive shell, and said first detector component includes a first resistor connected at one end to said conductive shell, the charge detect signal being generated across said first resistor.

14. The charging device as claimed in claim 13, wherein said first detector component further includes a series connection of a capacitor, a second resistor and a third resistor, the series connection being connected in parallel to said resistor.

15. The charging device as claimed in claim 1, which is for charging the first load and a second load simultaneously, wherein:
said load-connecting unit further includes a second output component connected electrically to said power-supplying unit and to be connected electrically to the second load for transferring the electricity from said power-supplying unit to the second load; and
said anti-theft unit further includes a second detector component connected electrically to said second output component and said control module;
wherein said second detector component is configured to generate a charge detect signal when the electricity from said power-supplying unit is being transferred to the second load through said second output component; and
wherein said control module is configured to deactivate said first alarm module in response to receipt of the charge detect signal from both of said first detector component and said second detector component.

16. The charging device as claimed in claim 15, wherein said control module includes a processor connected electrically to said first detector component, said second detector component and said first alarm module.

17. The charging device as claimed in claim 1, further comprising a casing unit, said casing unit including:
a base having said power-supplying unit and said first output component disposed thereon,
a support connected to said base and having said first alarm module disposed thereat, and
a top plate connected to said support and configured for placement of the first load thereon.
